(19) United States
(12) Patent Application Publication
(10) Pub. No.: US 2020/0062646 A1
(43) Pub. Date: Feb. 27, 2020

(54) SUSTAINABLE CONSTRUCTION MATERIAL AND METHOD OF PREPARATION AND USE THEREOF

(71) Applicant: National University of Singapore, Singapore (SG)

(72) Inventors: May Shuan NG, Singapore (SG); Harn Wei KUA, Singapore (SG); Souradeep GUPTA, Singapore (SG)

(21) Appl. No.: 16/610,005

(22) PCT Filed: Apr. 30, 2018
(86) PCT No.: PCT/SG2018/050206

§ 371 Date: Oct. 31, 2019

(30) Foreign Application Priority Data
May 2, 2017 (SG) 10201703565T

(51) Int. Cl. C04B 18/10; C04B 28/04; C04B 14/06; C09C 1/44; E04C 2/28

(52) U.S. Cl. CPC C04B 18/101; C04B 28/04; C04B 2111/00698; C09C 1/44; E04C 2/28; C04B 14/06

(57) ABSTRACT

The present invention relates to construction materials, in particular sustainable construction materials and methods of their preparation and use. Said construction material comprises biochar.

### FIELD OF THE INVENTION

The present invention relates to construction materials, in particular sustainable construction materials and methods of their preparation and use.

### BACKGROUND OF THE INVENTION

In recent years, development of sustainable construction material has become a necessity in the construction industry around the world to reduce the impact on the environment. For example, sand extraction for use the construction industry is reported to be associated with the destruction of ecosystems and damage to riverine and marine ecosystem, in addition to the high carbon emission arising from the quarrying and mining operations itself (Bournedjema et al., 2017; Lai et al., 2016). Therefore, several countries are limiting or prohibiting uncontrolled sand mining operations to address the alarming issue of environmental pollution.

It is therefore desirable to develop sustainable construction materials for the construction industry.

### SUMMARY OF THE INVENTION

The invention generally relates to construction materials, in particular sustainable construction materials and methods of their preparation and use. For example, the invention relates to biochar in construction materials.

According to a first aspect, the present invention relates to a method for preparing a construction material comprising the steps of:
(i) combining a binder, aggregate and biochar;
(iii) adding an aqueous solvent to form a mixture.

According to a second aspect, the construction material may be a wadding material. Accordingly, the present invention relates to a wadding material comprising biochar.

The invention also includes a method for preparing a wadding material comprising biochar.

### BRIEF DESCRIPTION OF THE FIGURES

FIG. 1: Particle size analysis of sand and biochar used.

FIG. 2: Experimental setup for identifying the biochar with the highest CO2 adsorption rate.

FIG. 3: The side and front views of wall panels containing biochar-coated plaster pellets.

FIG. 4: Experimental setup for testing the CO₂ adsorption of wall panels filled with biochar coated pellets or plaster pellets.

FIG. 5: Compressive strength development of biochar enhanced mortar with different percentage replacement of river sand.

FIG. 6: Biochar prepared from mixed wood saw dust.

FIG. 7: Biochar particle in hardened mortar paste.

FIG. 8: Flexural strength of biochar enhanced mortar with different percentage replacement of river sand.

FIG. 9: Sorptivity profile of biochar mortar with different replacement percentage of biochar.

FIG. 10: Coefficient of sorptivity of biochar mortar with different replacement percentage of biochar.

FIG. 11: Depth of water-penetration under pressure of mortar with biochar as partial sand replacement.

FIG. 12: Deposition of biochar particles inside voids in hardened mortar paste.

FIG. 13: Growth of calcium silicate hydrate gel into voids

FIG. 14. Drying shrinkage of plain mortar (control) and mortar with sand replacement using biochar

FIG. 15: Compressive and flexural strength of mortar samples with partial replacement of crushed rock sand at water-cement ratio (W/C) of 0.40.

FIG. 16: Compressive (cube strength, ASTM C109) and flexural strength of mortar samples with partial replacement of crushed rock sand at water-cement ratio (W/C) of 0.50.

FIG. 17: Sorptivity profile of mortar with partial replacement of crushed rock sand.

FIG. 18: Water absorption per unit area (g/cm2) of mortar samples with 2% of river sand and crushed rock sand replacement.

FIG. 19: Coefficient of sorptivity of mortar samples with 2% replacement of crushed rock sand.

FIG. 20: Experimental results with starting CO2 concentration of about 500 ppm. Top graph is for biochar coated plaster pellets, whereas the bottom one is for pellets made of plaster only. Wall cavity spacing is 30 mm.

FIG. 21: Experimental results with starting CO2 concentration of about 1,000 ppm. Top graph is for biochar coated plaster pellets, whereas the bottom one is for pellets made of plaster only. Wall cavity spacing is 30 mm.

### DEFINITIONS

As used herein, “aggregate” refers to a broad category of particulate material used in construction, including but not limited to sand, gravel, crushed stone, and/or slag, for example.

As used herein, “biochar” refers to a product obtained by thermal decomposition (or pyrolysis) of a biomass material (e.g., carbohydrate, cellulosic, protein-containing, and/or fat-containing material, such as wood, agricultural residue, manure, and the like). The thermal decomposition generally is performed at a temperature of less than 700° C. in an atmosphere that is lower in oxygen relative to normal air, in the absence or near absence of oxygen/air, in the presence of an inert gas or in a vacuum, and the biochar produced is typically a porous material that is carbon-rich which may also contain various levels of inorganic salts/minerals.

As used herein, “cement” means any inorganic substance that is capable of setting and hardening with water, as a result of the interaction of water with the constituents of the substance, to act as a binder for materials. Cement is seldom used on its own, but rather to bind aggregate together. Cement is used with fine aggregate to produce mortar for masonry, or with sand and gravel aggregates to produce concrete.

As used herein, “concrete” means any type of building material containing aggregates embedded in a matrix (cement or binder) that fills the space among the aggregates and glues them together. Typically; the aggregates are mixed with the binder and water and mixed together to form a fluid slurry which may be moulded into the desired shape. The binder hardens into a matrix that binds the aggregates forming a “stone-like” material that has many uses.

As used herein, the term “comprising” or “including” is to be interpreted as specifying the presence of the stated features, integers, steps or components as referred to, but does not preclude the presence or addition of one or more features, integers, steps or components, or groups thereof. However, in context with the present disclosure, the term “comprising” or “including” also includes “consisting of”. The variations of the word “comprising”, such as “comprise” and “comprises”, and “including”, such as “include” and “includes”, have correspondingly varied meanings.

As used herein, “mortar” refers to the material used in masonry (e.g. for binding construction blocks, bricks). Typically, aggregate in the form of a fine powder for example, a binding agent and an aqueous solvent (water) is mixed to form said material in the form of a paste. However, it will be appreciated that mortar may also be moulded.

As used herein, “wall panel” means a combination of one or more layers of various materials, having a front face and a rear face, for use in construction. In certain embodiments, two or more layers may be separated by a void. Examples of panels include, but are not limited to, sheets of drywall, metal, and other prefabricated walls and wall sections known in the art. The void may be filled with a wadding material.

### DETAILED DESCRIPTION OF THE INVENTION

Bibliographic references mentioned in the present specification are for convenience listed in the form of a list of references and added at the end of the examples.

The present invention relates to sustainable construction materials and methods of preparation and use thereof.

According to a first aspect, the present invention relates to a method for preparing a construction material comprising the steps of:
(i) combining a binder, aggregate and biochar;
(iii) adding an aqueous solvent to form a mixture.

In a subsequent step, the mixture is allowed to harden.

It will be appreciated that any suitable binder may be used for practising said method. For example, the binder includes but is not limited to cement.

It will be appreciated that any suitable aggregate may be used for practising said method. Examples of suitable aggregates include but is not limited to sand, gravel, crushed stone and/or slag and mixtures thereof.

It would be appreciated the aqueous solvent for practising the invention comprises water.

Any suitable biochar may be used to practice the invention. Biochar may be prepared from any biomass material and thermal decomposition at any temperature. For example, the thermal decomposition temperature may be from 200° C. to 700° C. It will be appreciated that any numerical value in this temperature range may be used for thermal decomposition. In particular, suitable thermal decomposition temperatures include but are not limited to 300° C. or 500° C.

It will be appreciated that any amount of biochar may be added to form the mixture. For example, the amount of biochar in the mixture may be 1% to 30% w/w of the mixture. Alternatively, the amount of biochar in the mixture may be 1% to 11% w/w of the mixture. It will be appreciated that any numerical value in this w/w range may be the amount of biochar in the mixture. In particular, the amount of biochar in the mixture may be ˜1.3%, ˜2.6% or ˜4.0% w/w.

The invention further includes a construction material obtainable by said method as described herein.

It will be appreciated that said method may be used to prepare concrete comprising biochar or a mortar comprising biochar. Accordingly, the invention includes a concrete comprising biochar or a mortar comprising biochar.

According to a second aspect, the construction material may be a wadding material. The wadding material and its preparation method will be appreciated by the detailed description herein.

The present invention further relates to a wadding material comprising biochar.

The wadding material may comprise pellets comprising biochar. As one example, the pellets may be coated with biochar. In particular, the pellets may comprise plaster, clay and/or plastic pellets coated with biochar.

It will be appreciated that in addition to biochar, the wadding material may comprise at least one other material. The biochar may be dispersed in said material. For example, the wadding material may comprise biochar and at least one material selected from plaster, clay or plastic. In another example, the wadding material may comprise pellets comprising biochar and at least one material selected from plaster, clay and/or plastic.

It will be appreciated that said material of the wall cladding may comprise any type of clay. An example of a suitable clay is bentonite clay.

It will also be appreciated that said material of the wall cladding may comprise any type of plastic.

The wadding material may be for filling a void space in a wall or wall panel. Accordingly, the invention also includes a method of filing void space in a wall or wall panel comprising filling the void space with the wadding material of the present invention.

In addition, the invention also includes a method for preparing a wadding material comprising biochar. The wadding material includes but is not limited to plaster, clay or plastic or combinations thereof.

In one example, the method comprises the step of providing a wadding material and adding biochar to the wadding material. Further, the wadding material comprising biochar may be moulded into pellets.

As another example, the method comprises providing pellets of a wadding material and coating the pellets with biochar. It will be appreciated that the pellets comprises plaster, clay and/or plastic.

Having now generally described the invention, the same will be more readily understood through reference to the following examples which are provided by way of illustration, and are not intended to be limiting of the present invention.

### EXAMPLES

### Example 1: Biochar Mortar

1.1 Materials Used

1.1.1 Cement and Sand Used

CEM1 52.5 N cement (Ordinary Portland Cement, OPC) was used in this study. Locally available natural sand with maximum size of 2.75 mm was used. The specific gravity and fineness modulus of sand used are 2.55 and 2.58 respectively

1.2 Key Properties of Biochar

Biochar was produced by slow pyrolysis of mixed wood saw dust (collected from a local saw mill) in limited supply of air. The biochar was prepared under two different pyrolysis temperature—300° C. and 500° C. The heating rate was maintained at 10° C./min while the pyrolysis time was carried out for 45 minutes. It was ensured that the saw dust used is sufficiently dry before production of biochar. After complete transformation of mixed wood saw dust into biochar, the produced char was allowed to stay in the oven for 30 minutes (holding time) before it was taken out for cooling down to room temperature. The properties of the biochar are shown in Table 1.

TABLE 1
Chemical composition (% by weight), pH
and bulk density of produced biochar

| | |
|---|---|
| Biochar prepared | Biochar prepared |
| at 300° C. | at 500° C. |
| (BC300) | (BC500) |

Elemental composition (%)

| | | |
|---|---|---|
| Carbon | 62.25 | 87.13 |
| Hydrogen | 7.17 | 5.01 |
| Oxygen | 25.60 | 7.21 |
| Calcium | 0.20 | 0.65 |
| Magnesium | 0.26 | 0.51 |
| Potassium | 0.42 | 0.42 |
| Silica | 0.40 | 0.40 |
| O/C ratio | 0.47 | |
| H/C ratio | 0.11 | |

Physical properties- pH, density and surface area

| | | |
|---|---|---|
| pH | 11.85 | 11.80 |
| Bulk density(g/cc) | 1.55 | 1.45 |
| Specific surface area (BET (m²/g) | 0.53 | 196.12 |
| Average pore diameter(nm) | 0.80 | |
| Total micro-pore volume in pores | 39.72 | 75.65 |
| (×10⁻³ cm³/g) | | |
| Water uptake capacity (g/g of | 7.35 ± 0.15 | 8.78 ± 0.22 |
| biochar) | | |

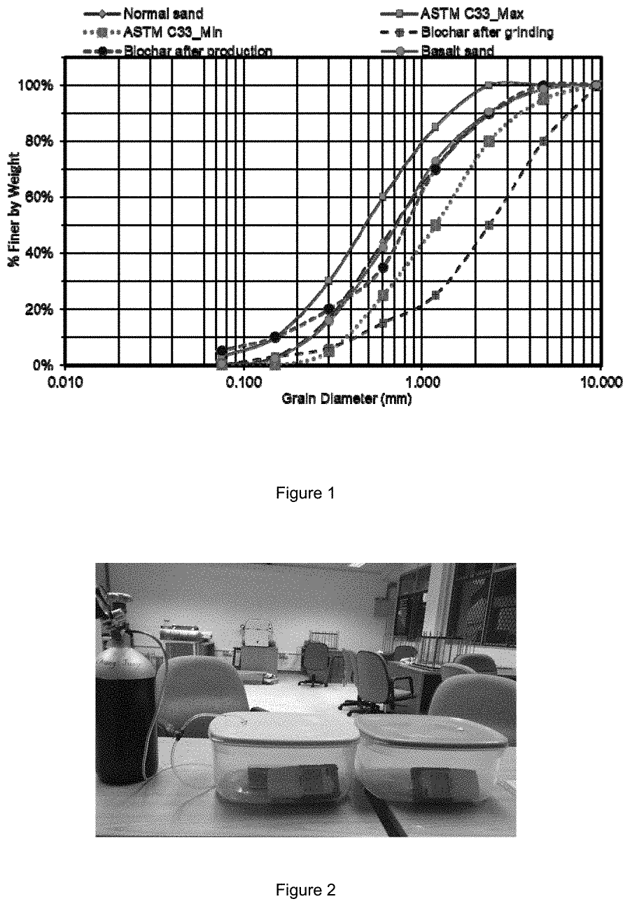

The biochar produced was grinded before mixing with cement mortar. The particle size distribution (PSD) determined by sieving of sand and biochar after production and grinding are presented in FIG. 1.

In this example, biochar was used to replace sand in the biochar mortar. However, it will be appreciated that the biochar may be used to replace any aggregate in mortar or concrete.

1.2 Experimental Method

1.2.1 Mixing, Placement and Curing of Mortar Specimen

Mixing of mortar components were carried out in a Hobert mechanical mixer at ambient temperature of 30° C. Solid materials including cement, sand and biochar (see Table 2) were dry mixed first for about 20 seconds followed by addition of water. The water was added slowly during mixing over 6-10 seconds. After 1 minute of mixing, superplasticizer (where applicable) was added and then mixing was carried out for 4 more minutes at medium speed and for about 1 minute at high speed. Finally, the edges of mixing bowl were scraped and mixing was conducted for about 3 minutes at medium speed. Total mixing time usually varied between 10-12 minutes.

The flow value for each mix was determined according to ASTM C1437-15 (ATSM. AST1437) and the flow value is also shown in Table 2. The mortar was then cast into moulds on a vibrating table to achieve sufficient compaction. The cast specimens were covered with polythene sheets for next 22-24 hours till demolding. After demolding, all the samples were transferred to fog room (100% relative humidity) for curing at temperature of 27±2° C. The samples were cured for 7 days and 28 days before they were taken out for strength and permeability testing.

TABLE 2
Mix proportions of different components in different types of mortar mix.

| | | | | | | Biochar | Superplasticizer | |
|---|---|---|---|---|---|---|---|---|
| | | Cement | Sand | Water | Biochar | content (% of | dosage (wt. % | Flow |
| Mortar mix | Mix description | (g) | (g) | (g) | (g) | total weight) | of cement) | (mm) |
| Plain mortar_river | Plain mortar (W/C = | 10,000 | 27500 | 4000 | — | — | 0.35 | 145 |
| sand (control 1) | 0.40) | | | | | | | |
| Plain mortar_crushed | | | | | | | | |
| rock sand (control 2) | | | | | | | | |
| 2% sand | Mortar with 2 wt. % | 10,000 | 26950 | 4000 | 550 | 1.3 | 0.60 | 140 |
| replacement_BC300 | sand replaced by | | | | | | | |
| | biochar prepared at | | | | | | | |
| | 300° C. | | | | | | | |
| 2% sand | Mortar with 2 wt. % | 10,000 | 26950 | 4000 | 550 | 1.3 | 0.56 | 138 |
| replacement_BC500 | sand replaced by | | | | | | | |
| | biochar prepared at | | | | | | | |
| | 500° C. | | | | | | | |
| 4% sand | Mortar with 4 wt. % | 10,000 | 26400 | 4000 | 1100 | 2.6 | 0.72 | 135 |
| replacement_BC300 | sand replaced by | | | | | | | |
| | biochar prepared at | | | | | | | |
| | 300° C. | | | | | | | |
| 6% sand | Mortar with 6 wt. % | 10,000 | 25850 | 4000 | 1650 | 4.0 | 1.3 | 118 |
| replacement_BC300 | sand replaced by | | | | | | | |
| | biochar prepared at | | | | | | | |
| | 300° C. | | | | | | | |

1.3 Tests Conducted

1.3.1 Compressive Strength

Compressive strength testing was conducted on cylinder samples (100 mm(d(x 200 mm(h)) following the loading conditions stated in BS EN 12390-3:2009 (BSI. BS EN 12390-3). Furthermore, strength development of biochar mortar at different water-cement ratio (W/C=0.50 to 0.35) was tested according to ASTM C109-16 (ASTM. ASTM C109/C109M). In this set of experiments, 50 mm cube samples were cast at constant dosage of 2% biochar by weight of cement.

1.3.2 Depth of Water Penetration

Depth of water penetration was measured using cylinder specimens loaded on to a calibrated water penetration apparatus (CONTROLS water permeability apparatus). Before the test, the cylinder specimens were dried in oven at 70° C. for 24 hours. The dried specimens were then coated with epoxy on the outer face to prevent leaking of water from the sides. Water pressure of 5±0.2 bar was applied for 72 hours. After 72 hours, the specimens were split into two halves and the maximum penetration depth (in mm) was recorded.

1.3.3 Sorptivity

The test was performed on 28 day old samples based on ASTM C1585-13 (ASTM C1585-13). 50 mm(h)×100 mm(d) samples were cut from 200 mm(h)×100 mm(d) cylinder samples using high speed concrete cutter. The samples were prepared and conditioned following the procedures stated in the standard. After the drying stage, the sides of the specimens were sealed with a layer of epoxy to stop absorption from the sides. The coating was allowed to dry for 24 hours. The test was carried out at 25±2° C. and relative humidity of 60±5%.

1.3.4 Determination of Drying Shrinkage

Drying shrinkage measures the length change of mortar bars upon loss of moisture. The shrinkage should be limited to avoid excessive shrinkage strain, that might cause cracking. Drying shrinkage was conducted as per ASTM C596 (ASTM. C 596) with some modifications. Fresh mortar was cast into 25×25×285 mm moulds and sealed until demoulding. After demoulding, the samples were immersed in water for 72 hours. The surface of wet samples were then wiped and first length measurement was recorded. The mortar samples were stored in a constant temperature-humidity room (26° C., 65% RH) during the test. Subsequent length measurements were done at interval of 1-3 days.

1.4 Results and Discussion

1.4.1 Replacement of River Sand

1.4.1.1 Compressive Strength

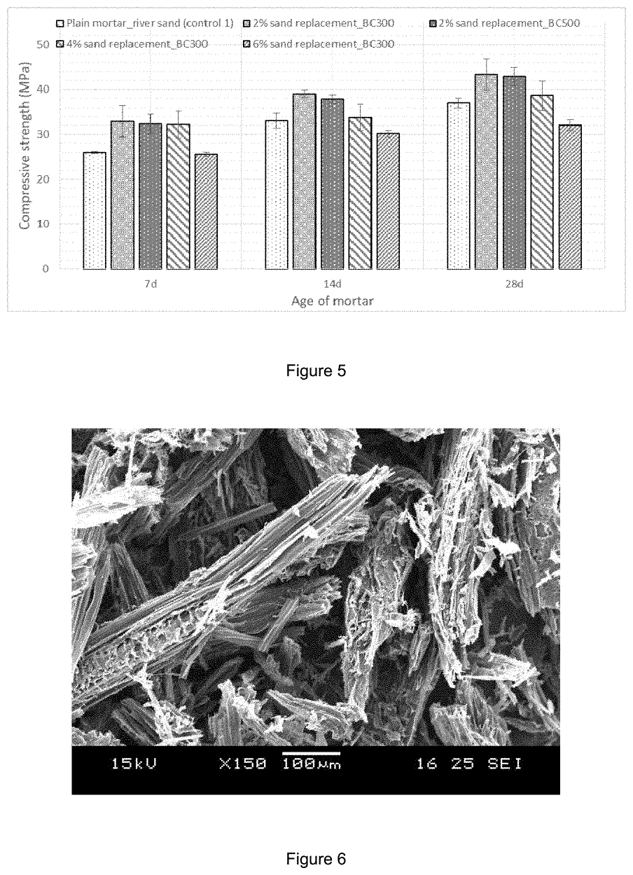

FIG. 5 shows the compressive strength results of mortar with different percentage replacement with BC300 and BC500 by weight. All the mixes were prepared with water-cement ratio of 0.40. Replacement of 2% river sand by biochar resulted in increase of compressive strength of mortar by 24% and 15% at 7 day and 28 day respectively. Increase in compressive strength is similar when BC500 is used to replace 2% of river sand. 4% replacement of sand by BC300 shows about 20% increase at 7 day while slight increase of strength at 28 day is observed compared to plain mortar (control 1).

However, 6% sand replacement with BC300 does not impact the strength of mortar. It is attributed to high increase in water demand of fresh mortar due to replacement of 6% of sand. Therefore, more voids are formed due to insufficient compaction of mortar mix. Furthermore, it can be observed from Table 2 that higher amount of superplasticizer was used to maintain sufficient flowability of the mix. Excessive use of superplasticizer may lead to formation of excessive foam and localized segregation that may affect strength development.

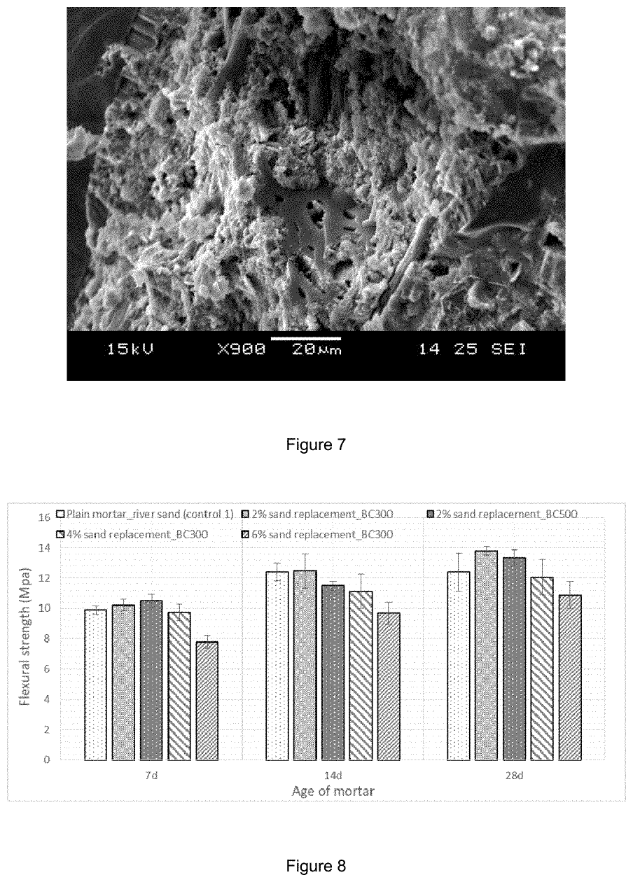

Improvement in strength due to 2% or 4% sand replacement by biochar is related to reduction of free water in mortar mix and action of biochar particles as micro-reinforcement. One can observe from Table 1 that biochar possesses high water absorption capacity (about 9 g/g of biochar). Therefore, incorporation of biochar in cement mortar is responsible for reduction of local water-cement ratio that results in densification of mortar matrix. The free water which is responsible for formation of capillary pores and voids is reduced because of water absorption property of biochar. The absorbed water is later supplied for internal curing once the mortar has hardened that promotes secondary hydration (Choi et al., 2012). In hardened mortar, when the amount of external water for curing is reduced, the water absorbed by biochar particles source for internal moisture (also known as ‘internal curing’) which contributes to precipitation of more binder paste and therefore, contribute to strength development. Biochar particles also reinforce mortar paste. Biochar particles being primarily composed of carbon has the potential of deviating crack trajectory (Restuccia et al., 2016). It means that biochar particles act as barrier to propagation of crack in mortar paste. Therefore, once a crack is initiated higher energy is consumed for propagation of crack before failure which results in increase of strength (Restuccia and Ferro, 2016; Ahmad et al., 2015). Another contributing factor is the shape of biochar particles. Biochar prepared from saw dust have rough surface and aged shapes (FIG. 6). Because of jagged and irregular shape the particles fit snugly in the mortar paste (FIG. 7), which can increase its effectiveness as micro-reinforcement.

1.4.1.2 Flexural Strength

FIG. 8 shows flexural strength of mortar at 7 day, 14 day and 28-day age with different replacement level of sand by biochar prepared at 300 and 500 degrees. One can observe that 2%—or 4% replacement of sand by biochar show similar flexural strength as plain mortar (control) at all ages of mortar. Therefore, it means that biochar as partial sand replacement does not affect flexural strength.

1.4.1.3 Sorptivity Profile and Coefficient Sorptivity

It is important to reduce sorptivity of mortar because absorption of water containing foreign and corrosive chemicals can be detrimental to serviceability of cement based materials. This property is even important when designing cement-based material for use in Singapore because the air contains high amount of moisture and salt. Moisture tends to travel through capillary pores or and interconnected pore network present in the mortar. Therefore, blockage of such pores would be instrumental in reduction of absorption.

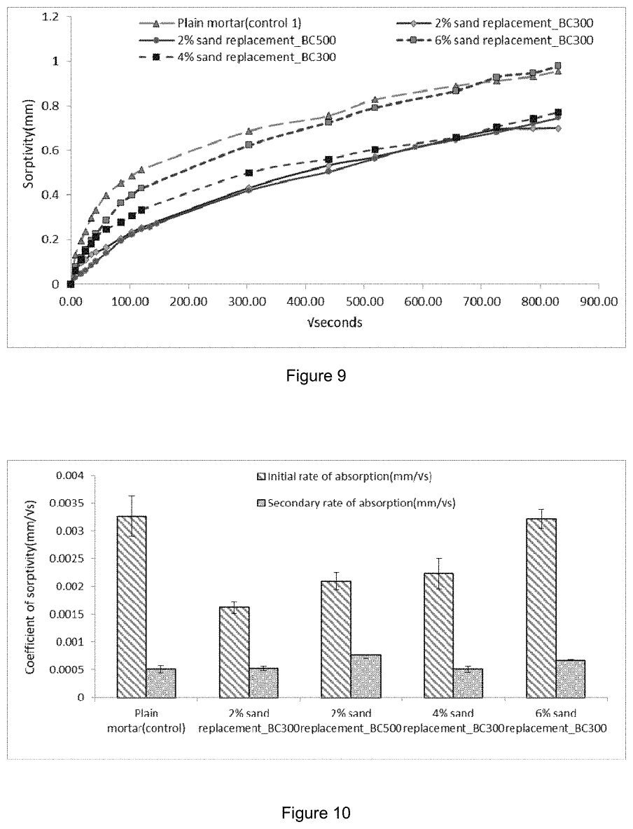

FIG. 9 shows that 2% and 4% replacement of sand by biochar significantly reduce sorptivity of mortar compared to plain mortar. On broad classification, pores are categorized into two types as introduced by Powers, 1946—gel pores (typically <10 nm) which are part of C—S—H gel phase, and capillary pores which forms due to evaporation of excess water. Coefficient of initial sorptivity, which is caused by transport of moisture through fine capillary pores and gel pores, is reduced by 44% and 25% by replacement of 2% and 4% sand respectively by biochar compared to plain mortar (control 1).

Capillary porosity is the most important parameter that influences permeability of cementitous mortar. Due to biochar's water absorption capacity, the excess water in the mortar paste is significantly reduced which leads to reduced formation of capillary pores by evaporation of free water. Later the physically absorbed water in biochar is supplied to the surrounding mortar paste which generate a self-curing effect (Choi et al., 2012), leading to densification of pore structure. In addition, the interfacial zone between cement paste and fine aggregates is porous with pore sizes ranging between 20-50μ which affects transport of moisture (Mindess et al., 2003). Fine biochar particles have micro-filler effect that blocks voids and capillary pores. The pore blocking effect can be further improved by higher degree of mechanical grinding of produced char.

1.4.1.4 Water Penetration Under Pressure

Water from ground or rain water can penetrate into mortar through voids and pores. Water dissolves many foreign chemicals and harmful contaminants which are transported along with it into the mortar. It results in faster degradation of mortar through undesirable expansion, leaching and cracking. Therefore, the depth of water penetration must be limited to ensure better performance over lifetime of civil infrastructure.

The influence of partial sand replacement by biochar on reduction of water penetration depth is evident from FIG. 11. 2% sand replacement by BC300 and BC500 have reduced the penetration depth by 56% and 25% respectively, meaning the biochar enhanced mortar has significantly higher resistance to penetration of water under pressure. However, the resistance to water penetration is reduced as the replacement percentage is increased. Sand replacement by up to 4% show significant reduction in water penetration while 6% replacement show similar penetration depth as plain mortar.

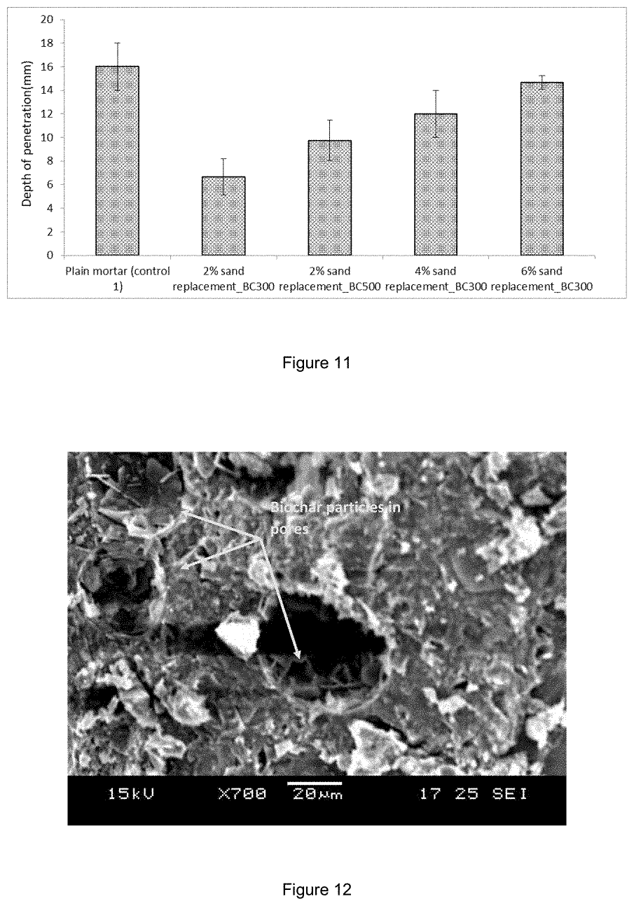

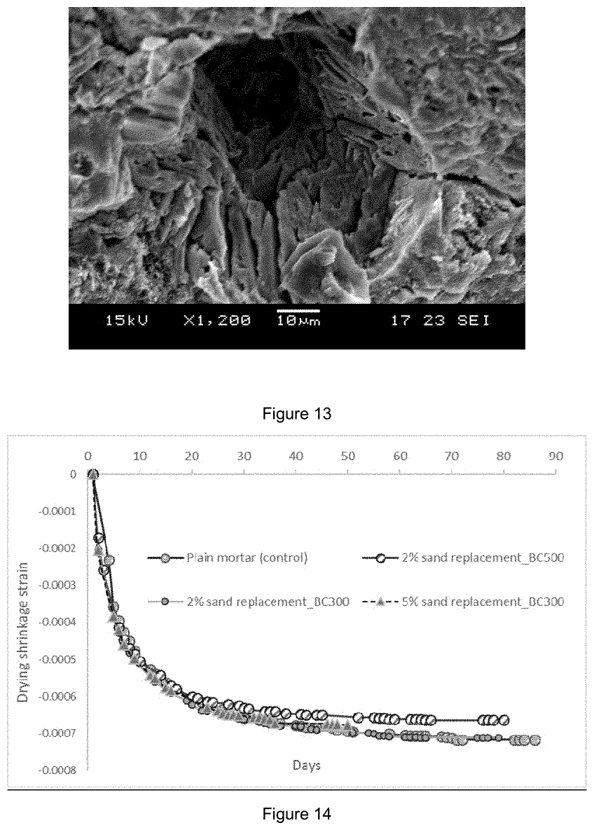

Scanning electron microscopic images show that voids in mortar are occupied by flaky shaped biochar particles (FIG. 12). The finer fraction of biochar particles, less than 50 μm can deposit inside the voids and pores, and break the connectivity of the pore network for penetration of water. In case of plain mortar, the closure of voids depends on the precipitation of hydration products that grown and deposit inside the voids (FIG. 13). However, this mechanism of precipitation is dependent on availability of water and takes longer time to obtain a disconnected pore network. Moreover, the binder phase (calcium silicate hydrate) deposited in the voids of plain mortar also contain pores (FIG. 13). It is generally agreed that the calcium silicate hydrate (C—S—H) formed in voids resulting from evaporation of water is less dense and contain pores (Yu et al., 1999), which is also observed in FIG. 13. Although low density C—S—H is important for reducing pore volume of mortar paste, it may be concluded from sorptivity and water penetration result that addition of biochar has more distinguished effect on reduction of porosity and blockage of pore systems.

1.4.1.5 Drying Shrinkage

FIG. 14 shows the drying shrinkage strain of control mortar and mortar with 2% and 5% sand replacement by biochar made at 300° C. and 500° C. It can be observed that maximum shrinkage takes place within first two weeks. The shrinkage strain is steady once the mortar reaches 40-day age. 2% and 5% sand replacement by weight with BC 300 produce similar shrinkage as plain mortar, while 2% sand replacement by BC 500 show slightly lower shrinkage at 80-day age compared to plain mortar (control).

Slight reduction of 80-day shrinkage in mortar with partial sand replacement by BC 500 can be attributed to higher water absorption and retention capacity of BC 500 compared to BC 300 due to higher fraction of pores in BC 500. The water absorbed in pores of BC 500 is later supplied for hydration, which effectively reduces shrinkage due to loss of moisture from pore spaces in hardened mortar. At the end of 56-day period, 2% and 5% replacement of sand by BC 300 and BC 500 produced shrinkage of 705.33±3.70μξ, 658±2.60μξ and 680±4.60μξ respectively, which were lower than 750μξ as recommended by Australian standard AS 3660 (Standard A. AS 3600)

It is clear from the results that partial sand replacement by biochar does not alleviate shrinkage behaviour as much as its effect on improvement of strength and reduction of permeability. Shrinkage of cementitous matrix is influenced by porosity, size and shape of pores and continuity of capillary system (Altchin et al., 1997) Biochar particles comprise of micro-pores and macro-pores, size ranging between 5 and 20 μm. Although water absorption and retention property of biochar can reduce the local free water during initial hardening stage, the pores of biochar themselves provided a transport network for moisture within the matrix. Moreover, due to lower modulus compared to mortar paste, biochar particles may not have significant restraining effect on shrinkage of hardened paste.

1.4.2 Replacement of Crushed Rock Sand

1.4.2.1 Mechanical Strength—Compressive and Flexural Strength

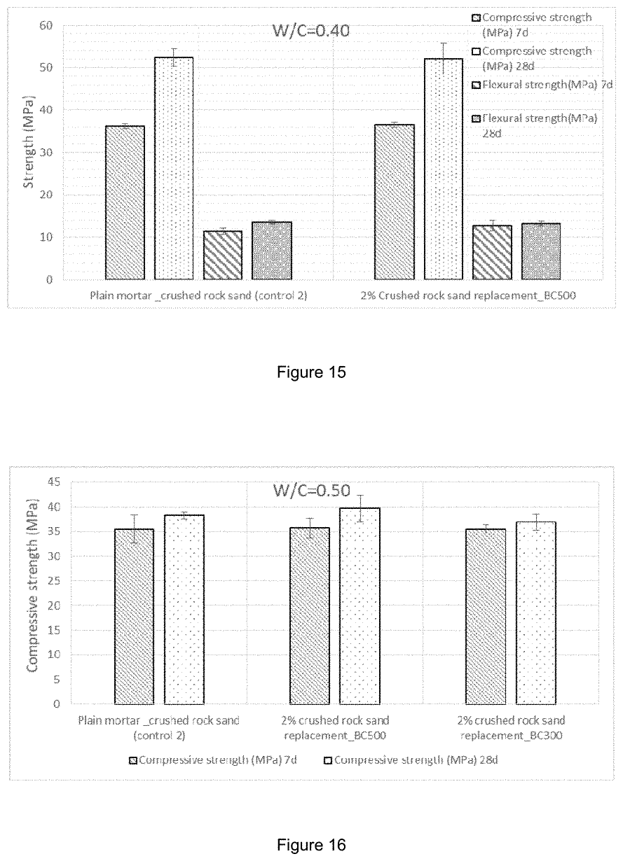

FIGS. 15 and 16 show mechanical strength of mortar sample prepared with 2% replacement of crushed rock sand by biochar at water-cement ratio of 0.40 and 0.50 respectively. It can be seen from the figures that compressive and flexural strength of mortar samples after 2% replacement of crushed rock sand is similar to control sample with crushed rock sand. It means that use of biochar to replace part of crushed rock sand does not have significant influence on strength improvement. The trend is different from the case of river sand where significant improvement in strength was observed at similar replacement level of sand. Crushed rock sand particles are tougher compared to river sand, and therefore contribute to strength development. Replacement of tough sand particles by low density, porous biochar may offset the advantages realized by partially replacing sand with biochar.

1.4.2.2 Effect on Sorptivity

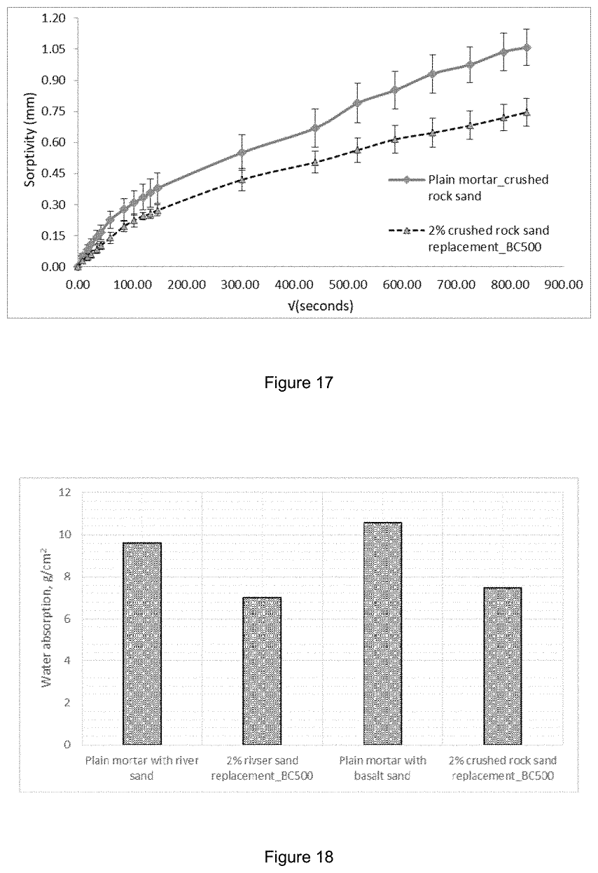

FIG. 17 shows the sorptivity profile of mortar samples with 2% replacement of crushed rock sand and normal sand in mortar. As observed from FIG. 17, replacement of crushed rock sand reduces sorptivity of mortar. It means that the amount of water absorbed by the mortar over the period of testing is lower when 2% sand is replaced by biochar. Amount of water absorbed per unit area of exposed face of sample to water over the sorptivity test period is shown in FIG. 18. It is clearly observed that partial replacement of basalt sand and normal sand by biochar significantly reduces water absorption per unit area (g/cm²). 2% normal sand replacement and 2% crushed rock sand replacement by biochar show a reduction in water absorption by 16% and 28% respectively.

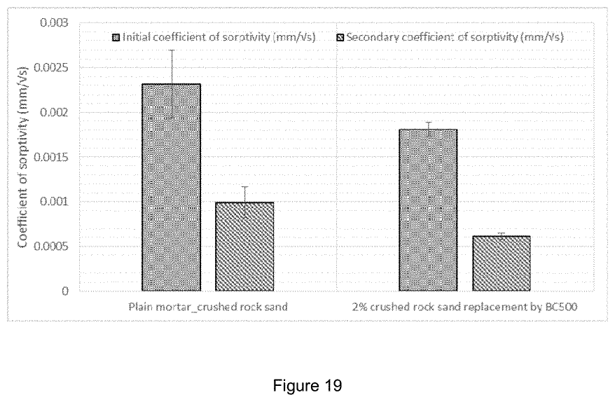

Sorptivity results indicate that partial replacement of sand by biochar has significant influence on improvement of mortar impermeability to water irrespective of type of sand used. This is different from the strength results with 2% crushed rock sand replacement with biochar, where biochar did not show any significant impact on strength. It is worth noting that strength development primarily depends on degree of hydration and strength of materials added in the composite. However, permeability is influenced by reduction of open porosity of the mortar paste, which could be achieved by either deposition of hydration products or pore blocking by a filler material. Although biochar is not as tough as sand derived from crushed rocks, it can block the pore network that reduced the ingress of moisture into the mortar. It is also reflected in reduction of coefficient of sorptivity, shown in FIG. 19. A reduction of initial coefficient and secondary coefficient of sorptivity by 22% and 38% is observed when 2% of crushed rock sand is replaced by biochar prepared at 500° C.

1.4.3 Conclusion

Based on the results, the following conclusions can be drawn

a) Replacement of 2-4 wt. % of sand by biochar does not significantly affect flowability of mortar mix. However, at higher replacement level (6%), mortar mix tend to become stiff and due to high water absorption by biochar, which may result in insufficient compaction.

b) 2-4 wt. % replacement of river sand by biochar significantly improve compressive strength of mortar, although replacement of crushed rock sand by biochar resulted in similar strength as control.

c) Depth of water penetration is reduced by 2-4 wt. % replacement of normal sand by biochar prepared at 300° C. and 500° C. It can be concluded that introduction of biochar as partial sand replacement reduced water permeability of hardened mortar.

d) Biochar particles in mortar can reduce open porosity which resulted in prominent reduction in water absorption and coefficient of sorptivity irrespective of the type of sand replaced. It means that permeability of mortar to moisture can be significantly reduced by using biochar as a material to partially replace sand. Reduction of sorptivity is an important criterion for improved durability of mortar that would offer better serviceability and longer service life of the structure using biochar-enhanced cement mortar.

Incorporation of material derived from waste in cementitious composite would save natural resources, promote recycling, and reduce the need for landfilling. The use of biochar as cementitious admixture would promote waste recycling and have the potential to significantly reducing the land area required for waste disposal. Biomass which may be wood waste, agricultural waste or food waste may be processed to make biochar that could be further used as a construction material.

### Example 2 Wall Wadding

2.1 Heating Rate for Desorption of Biochar

In a separate experiment, biochar was produced from mixed wood wastes taken from a local recycler. The production process involves heating the wood wastes in a gasifier under the temperature of between 550-600° C. for around 3-4 hours. The biochar was further grinded into powder form in the laboratory.

Since the biochar was left in the open for a number of days before our study, we subjected the biochar-coated pellets to a process of desorption, so that adsorbed carbon dioxide (CO₂) can first be removed before we assessed how much CO₂ the biochar can adsorb. Based on an earlier study, we know that heating biochar at a temperature of around 500° C. will “drive out” any adsorbed CO₂ molecules while not causing the biochar particles to be combusted off. To know how long to heat the biochar, the following steps were followed:
a. 30 g of biochar sample was placed inside a furnace.
b. The biochar sample was then heated in a furnace at 500° C. for 2, 3 or 4 hours.
c. After the heating and subsequent cooling process, the mass of the remaining biochar was determined. This tells us the yield of the heating process.
d. 3 g of desorbed biochar sample was placed inside a tank together with a Telaire CO₂ analyzer (model number 7001) as shown in FIG. 2.
e. 2000±50 ppm of CO₂ was introduced into the tank from a CO₂ cylinder. Readings of the CO₂ concentration was recorded for 4 hours. The objective is to find the heating duration that produces high yield of heating and the biochar produced has high CO₂ adsorption rate.

Balancing between the two requirements described in (e) above, it was found that a heating duration of 3 hours is the best. This heating duration was then chosen for desorbing the biochar coated pellets in the next stage.

2.2 Plaster

The substrate material for the pellets was made with 1 part water and 3 parts plaster (that is, water and plaster in a ratio of 1:3). This combination was chosen because it was found that pellets could more easily be made by hand with such a mixture. The biochar powder was then sprinkled on to a new batch of wet plaster pellets and air-dried for about an hour to ensure that the adherence between the plaster mixture and biochar powder remained strong. All the pellets have a diameter of approximately 15 mm. Alternatively, the biochar powder can also be mixed with the plaster to make into pellets. Other than plaster, clay (e.g. bentonite clay) and plastic may also be used instead of plaster to make the pellets.

Completed biochar-coated pellets were then heated at 500° C. for 3 hours (as indicated above) to desorb the CO₂. These desorbed pellets were then tested for their adsorption capability.

2.3 Wall Panel Construction

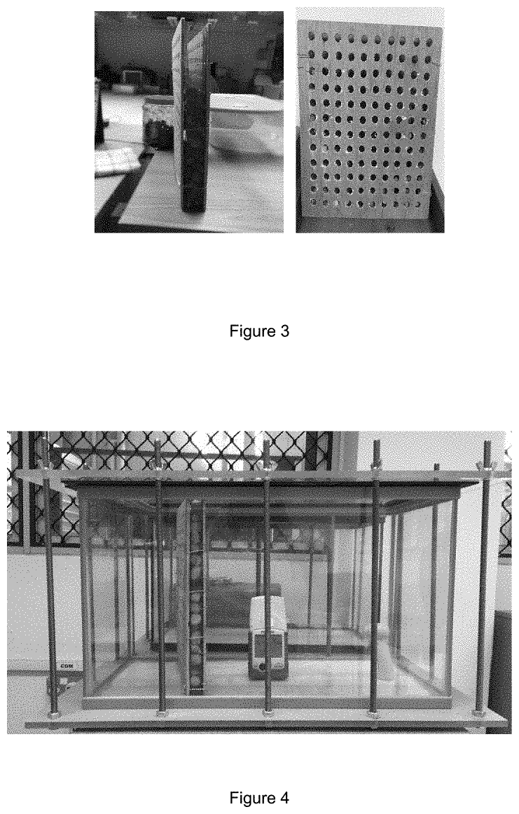

A wall panel of the form shown in FIG. 3 was made. Two configurations of such a wall panel were tested—one type with a cavity thickness of 15 mm and another type with a 30 mm cavity. These values were chosen because they coincide with thicknesses of walls that are commonly used in the industry.

The experimental procedure for the CO₂ adsorption experiment is as follows:
a. The cavity of the wall panel was filled with desorbed biochar pellets, or plaster pellets only (these served as control samples), in an air-tight enclosed tank.
b. The wall was placed vertically inside the tank, positioned nearer to one side of each tank (as shown in FIG. 4). A small electric fan (to circulate the air flow) and Telaire 7001 were then placed inside each tank.
c. The tanks were then tightly sealed. CO₂ was introduced into the tank through a tube until CO₂ concentration reaches around 500 or 1,000 ppm.
d. Readings of the CO₂ concentration was recorded at 5 minutes interval for 2 hours. Eventually, readings were adjusted for any measured air leakage.
e. Step (a) to (d) was repeated for another 2 trials.

The reason that 500 and 1,000 ppm starting concentrations were chosen is that 500 ppm is the usual indoor concentration in NUS, and 1,000 ppm is commonly accepted as the upper limit to indoor concentration. It is also worth noting that the above (a)-(e) were also administered for the control sample—pellets made from plasters only—to assess the amount of CO₂ that the biochar coating itself can adsorb when deployed on the pellets. Besides plaster, clay and plastic can also be used to prepare pellets

2.4 Carbon Dioxide Sequestration of Biochar Pellets

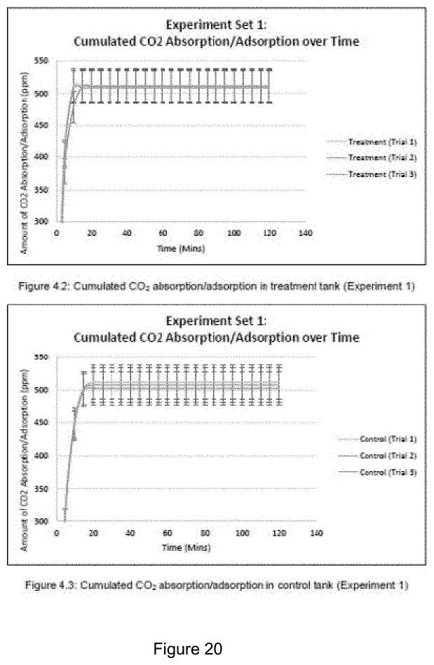

FIG. 20 shows that although both types of pellets eventually reduce the interior CO₂ concentration (in the tanks) to zero, the biochar coating is able to achieve the reduction in half the amount of the time taken by the control sample (plaster pellets).

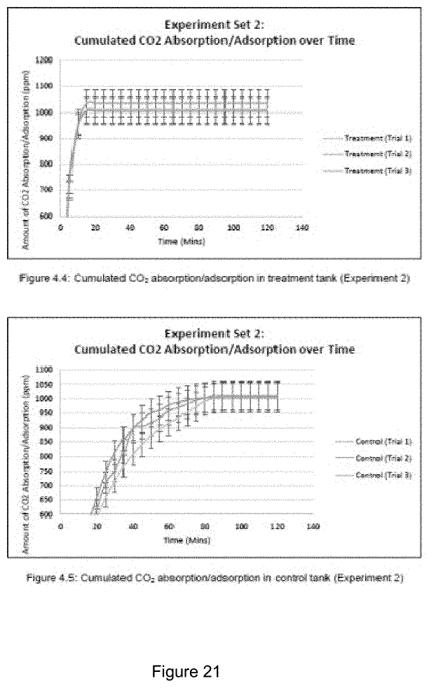

As shown in FIG. 21 below, this advantage is even more prominent at the higher concentration (1,000 ppm)—the biochar coating is able to reduce the concentration 8 times faster.

Accordingly, the pellets were found to be effective in sequestering carbon dioxide from the indoor environment. This shows that such biochar pellets can be a low cost material for enhancing indoor environment and mitigating climate change. Other than plaster, plastic and clay can also be used for the pellets.

2.3 Environmental Benefits of this Technology

Biochar made from gasification of mixed wood wastes was used to coat pellets made with plaster (alternatively bentonite clay may be used to make the pellets), and these pellets are used as fillings in cavities of special interior partition wall panels. These pellets were found to be effective in sequestering carbon dioxide from the indoor environment. This shows that such biochar pellets can be a low cost material for enhancing indoor environment and mitigating climate change.

In the setup with 30 mm cavity, the total mass of biochar used for the biochar coating was only about 6 g. Using the Idea Gas Law as an estimation, we found that within the first 10 minutes, biochar coated pellets can potentially remove 0.021 mmol/g and 0.199 mmol/g of biochar at starting concentration of 500 and 1,000 ppm respectively. If more CO₂ was introduced into the tank as soon as the total cumulative adsorbed CO₂ reached a plateau, even more CO₂ could have been adsorbed by the pellets. Hence, these adsorption values (0.021 mmol/g and 0.199 mmol/g) can be seen as the minimum values of adsorption by the pellets.

A typical indoor partition wall can measure 6 m wide and 3 m high; this can be made up of 180 units of the experimental panel we tested. If 3 layers of our experimental panel (with 30 mm cavity) are applied (since a wall can be about 110 mm thick), the entire wall can contain about 3.24 kg of biochar. Using the above minimum adsorption values as a guide, the said wall can potentially adsorb 30 grams of CO₂, within the first 10 minutes, provided the starting concentration is 1,000 ppm.

In a multi-storied commercial building, depending on the design of the interior space and gross floor area, it is possible to have at least 100 units of such 6 m-by-3 m partition walls, with a potential of capturing and storing 3 kg of CO₂ in just one installation. That is, if the biochar coated pellets can be replaced twice a month, a 30-story commercial building can potentially remove more than 2 tonnes of CO₂ in one year.

Finally, the fact that the biochar was derived from wood wastes implies that this is a technology that turns wastes into carbon sequestering products. In other words, economic benefits may be gained from the utilization of agricultural or horticultural wastes (either as a result of sale of the wastes or avoidance of tipping fees), as well as sale of carbon credits generated from the carbon abatement of this product. Biochar as additive is not only sustainable but also a cost-effective solution to improve mortar properties, because it is derived from bio-waste and production and mixing of biochar in mortar does not require any special technique or sophisticated set-up which many developing countries may not be willing to invest.

Depending on the type of feedstock and preparation conditions used, biochar has the potential of reducing net greenhouse gas (GHG) emissions by about 870 kg CO₂ equivalent (CO₂-e) per tonne dry feedstock, of which 62-66% are realized from carbon capture and storage by the biomass feedstock of the biochar (Roberts et al., 2009). Using biochar to make wall fillings is another way of recycling biomass waste (for example agricultural or horticultural waste).

### CONCLUSION

The above examples show that biochar not only promotes recycling of waste but also sequester huge volume of carbon in cementitious composites.

### REFERENCES

Any listing or discussion of an apparently prior-published document in this specification should not necessarily be taken as an acknowledgement that such document is part of the state of the art or is common general knowledge.
Ahmad S, Tulliani J M, Ferro G A, Khushnood R A, Restuccia L, Jagdale P. Crack path and fracture surface modifications in cement composites. Frattura ed Integritá Strutturale. 2015(34).
Aitcin P-C, Neville A, Acker P. Integrated view of shrinkage deformation. Concr Int. 1997; 19(9):35-41.
ASTM. ASTM C109/C109M: Standard Test Method for Compressive Strength of Hydraulic Cement Mortars (Using 2-in. or [50-mm] Cube Specimens). West Conshohocken, Pa., United States: ASTM International; 2016.
ASTM. C 596: Standard Test Method for Drying Shrinkage of Mortar Containing Hydraulic Cement. West Conshohocken, Pa., United States: ASTM International; 2001.
ASTM. ASTM C1437: Standard Test Method for Flow of Hydraulic Cement Mortar. West Conshohocken, Pa., United States: American Society for Testing and Materials International; 2015.
ASTM C1585-13: Standard Test Method for Measurement of Rate of Absorption of Water by Hydraulic-Cement Concretes. ASTM; 2013.
Bounedjema Y, Ezziane K, Hallal A. Variation of mechanical and rheological properties of mortar by replacement of natural sand with crushed sand. J Adhes Sci Technol. 2017; 31(2):182-201.
BSI. BS EN 12390-3: Testing hardened concrete. Compressive strength of test specimens. London, United Kingdom: British Standards Institution; 2009.
Choi W C, Yun H D, Lee J Y. Mechanical Properties of Mortar Containing Bio-Char From Pyrolysis. Journal of the Korea institute for structural maintenance and inspection. 2012; 16(3):67-74.
Lai L W, Chau K, Lorne F T. The rise and fall of the sand monopoly in colonial Hong Kong. Ecological Economics. 2016; 128:106-16.
Mindess S, Young J F, Darwin D. Concrete. Upper Saddle River, N.J., U.S.A: Prentice Hall; 2003.
Powers T C, Brownyard T L. Studies of the physical properties of hardened Portland cement paste. Journal Proceedings 1946. p. 101-32.
Roberts K G, Gloy B A, Joseph S, Scott N R, Lehmann J. Life cycle assessment of biochar systems: Estimating the energetic, economic, and climate change potential. Environmental science & technology. 2009; 44(2):827-33.
Standard A. AS 3600 Concrete structures-incorporating AMD 1: May 2002 and AMD 2. 2004.
Yu P, Kirkpatrick R J, Poe B, McMillan P F, Cong X. Structure of calcium silicate hydrate (C—S—H): Near-, Mid-, and Far-infrared spectroscopy. J Am Ceram Soc. 1999; 82(3):742-8.

1. A method for preparing a construction material comprising:
(i) combining a binder, aggregate and biochar;
(iii) adding an aqueous solvent to form a mixture.

2. The method according to claim 1, further comprising allowing the mixture to harden.

3. The method according to claim 1, wherein the binder comprises cement.

4. The method according to claim 1, wherein the aggregate comprises sand, gravel, crushed stone and/or slag and mixtures thereof.

5. The method according to claim 1, wherein the aqueous solvent comprises water.

6. The method according to claim 1, wherein the biochar is prepared by thermal decomposition of a biomass material at a temperature of 200° C. to 700° C.

7. The method according to claim 1, wherein the biochar is prepared by thermal decomposition of a biomass material at a temperature of 300° C. or 500° C.

8. The method according to claim 1, wherein the biochar is prepared by thermal decomposition of a biomass material at a temperature of 300° C.

9. The method according to claim 1, wherein the biochar is prepared by thermal decomposition of a biomass material at a temperature of 500° C.

10. The method according to claim 1, wherein the amount of biochar in the mixture is from 1% to 30%.

11. A construction material obtainable by the method according to claim 1.

12. A construction material comprising a concrete comprising biochar or a mortar comprising biochar.

13. A wadding material comprising biochar.

14. The wadding material according to claim 13 comprising pellets comprising biochar.

15. The wadding material according to claim 14 comprising pellets coated with biochar.

16. The wadding material according to claim 13, wherein the wadding material comprises biochar and at least one material selected from plaster, clay and/or plastic.

17. The wadding material according to claim 14, wherein the pellets comprises biochar and at least one material selected from plaster, clay and/or plastic.

18. The wadding material according to claim 15, wherein the pellets comprises plaster, clay and/or plastic pellets coated with biochar.

19. The wadding material according to claim 13 for filling a void space in a wall or wall panel.

20. A method of filling void space in a wall or wall panel comprising filling the void space in a wall or wall panel with the wadding material according to claim 13.

21. A method for preparing a wadding material comprising biochar.

22. The method according to claim 21, comprising the step of providing a wadding material and adding biochar to the wadding material.

23. The method according to claim 22, further comprising moulding the wading material comprising biochar to form pellets.

24. The method according to 22, comprising providing pellets of a wadding material and coating the pellets with biochar.

25. The method according to claim 21, wherein the wadding material comprises plaster, clay and/or plastic.

26. The method according to claim 24, wherein the pellets of the wading material comprises plaster, clay and/or plastic.

27. The method according to claim 21, further comprising filling the void space in a wall or wall panel with the wadding material.
